(19) United States
(12) Patent Application Publication
(10) Pub. No.: US 2026/0034549 A1
(43) Pub. Date: Feb. 5, 2026

(54) TRANSPORT SECURING MEANS FOR A SEPARATOR INSERT OF A SEPARATOR

(71) Applicant: GEA WESTFALIA SEPARATOR GROUP GMBH, Oelde (DE)

(72) Inventors: Andreas SCHULZ, Beckum (DE); Dennis NEUFELD, Oelde (DE); Kai HELMRICH, Drensteinfurt (DE)

(21) Appl. No.: 18/997,304

(22) PCT Filed: Jul. 5, 2023
(86) PCT No.: PCT/EP2023/068514

§ 371 Date: Jan. 21, 2025

(30) Foreign Application Priority Data
Jul. 22, 2022 (DE) 20 2022 104 151.2

(51) Int. Cl. B04B 7/06; B04B 1/08; B04B 9/02; B04B 9/12

(52) U.S. Cl. CPC B04B 7/06; B04B 1/08; B04B 9/02; B04B 9/12

(57) ABSTRACT

An exchangeable separator insert is designed for insertion into stator magnets of the frame of the separator and includes a housing, which is stationary during operation and which is designed in the manner of a container that is closed except for one or more openings. A rotor is disposed within the housing and is rotatable about an axis of rotation, the rotor having a drum which has one or more openings. At least two rotor magnets are at two axially spaced points of the rotor to keep floating and rotatably support the drum within the housing during operation. For transport or installation, the separator insert is provided with one or more transport securing elements, which operate according to a magnetic principle of action, so that the drum, which freely floats during operation of the separator, is immovable or substantially immovable in the housing during transport or installation.

### BACKGROUND AND SUMMARY OF THE INVENTION

Exemplary embodiments of the invention relate to a transport securing means for a separator insert of a centrifuge.

Separators as defined in this document are used to separate a free-flowing suspension as a starting product in a centrifugal field into phases of different densities.

DE 10 2017 128 027 A1 discloses a separator with a disk assembly and disposable plastic components (single-use technology—single use of pre-qualified plastic parts). Such separators with single-use components are particularly suitable for use in biotechnology or pharmaceuticals. In this separator, the bearing devices are designed as magnetic bearings and one of the magnetic bearing devices is preferably also used as a drive device for rotating the drum, which is held in suspension during operation. This eliminates the need for mechanical components for rotating and bearing the drum, which favors the design as a separator with a separator insert for single use, as replacing this separator insert is very easy to handle.

A further development of this separator is known from DE 10 2020 121 419 A1. Disclosed is a separator having a frame and a separator insert arranged exchangeably on the frame, wherein the separator insert is designed for separating a flowable suspension in a centrifugal field into at least two flowable phases of different densities and forms a preassembled, exchangeable unit for insertion into stator units on the frame of the separator.

The separator insert of DE 10 2020 121 419 A1 also has a static housing and a rotor that is magnetically/levitronically mounted during operation. During operation, the rotor is held in suspension by the magnetic bearings of the frame. Outside of operation, when the magnetic bearings are not active—e.g., during transportation or mounting in a frame provided for this purpose—the rotor is in an undefined state in the housing, as it is neither axially nor radially fixed without an additional transportation lock. During transportation, this could lead to damage to the drum and its internals, such as the disk assembly and the distributor, or to the housing and its internals, such as feed lines and discharge lines.

It is known from DE 10 2015 108 272 A1 that mechanical transport securing means are used to avoid similar problems. For example, an internal tongue is used as a transport securing means, but this is located in the product flow, which is disadvantageous. Furthermore, a combination of an internal groove and a geometrically corresponding lug is disclosed as another possible transport securing means. The disadvantage here is that the inner drum must be rotated in order to guide the groove and lug into one another. This is not possible with a separator insert according to DE10 2020 121 419 A1. Furthermore, an external clamping ring is described as a transport securing means. To mount the clamping ring, it is necessary to lift the inner drum axially upwards, which is not easily possible with the closed separator insert. A further disadvantage results from the deformation of housing-forming components by the clamping ring.

Exemplary embodiments of the invention are directed to solving these problems and to obtain a simply designed yet effective transport securing means for a separator insert of the type according to the invention, in particular according to DE10 2020 121 419 A1.

According to an embodiment there is separator insert for a separator, wherein the separator insert forms a preassembled, exchangeable unit which can be inserted into a frame and which is designed to separate a flowable suspension in a centrifugal field into at least two flowable phases of different density, wherein the exchangeable separator insert is designed for insertion into stator magnets on the frame of the separator and has at least the following:
a housing which is stationary during operation and is designed in the manner of a container which is closed except for one or more openings,
a rotor which is arranged within the housing and can rotate about an axis of rotation and has a drum which has one or more openings,
preferably a separator disk assembly arranged in the drum,
at least two rotor magnets at two axially spaced points of the rotor having the drum, by means of which the rotor magnets the drum having the drum can be held in suspension and rotatably supported within the housing during operation,
wherein the separator insert is equipped with one or more transport securing elements for transportation or assembly, which work according to a magnetic operating principle,
so that the drum, which is free-floating during operation of the separator, is immovable or substantially immovable in the housing during transport or installation.

The rotor and thus also the rotor magnets can be rotated in the housing and can be moved axially and/or radially to a limited extent or are not fixed rigidly in the housing.

The invention provides an easy-to-handle and reliably functioning transport securing means for the separator insert of a separator that operates according to the principle of single-use technology. As a result, damage to the drum and its internals, such as the disk assembly and the distributor, or also to the housing and its internals, such as feed lines and discharge lines, during transport or during assembly of the separator insert is advantageously virtually eliminated in a simple manner. Furthermore, this provides hygienically perfect transport protection.

Terms such as below and above refer to a preferred vertical alignment of the axis of rotation of the rotor and, if the axis of rotation is aligned at an angle or horizontally, must be considered in a coordinate system rotated in space corresponding to the vertical alignment of the rotor and the housing.

According to a particularly preferred embodiment variant of the invention, it is provided that the transport securing elements work according to a ferromagnetic operating principle. This results in a particularly simple design of the one or more transport securing elements, which reliably fulfill their main function without external energy and are advantageously easy to handle and install.

It is particularly preferably provided that the respective transport securing element can be placed or is placed on the outside of the housing in such a way that it moves the respective rotor magnet and thus the entire rotor in the direction of and preferably against a housing wall, so that the freedom of movement of this rotor magnet and thus of the corresponding rotor section in the housing is restricted.

It is also advantageous if the transport securing element or elements have a circular ring sector-shaped geometry. This makes it easy to achieve a defined fixed position of the rotor in the assembled state in accordance with the arrangement of the circular ring sector-shaped transport securing element(s) on the outside of the housing. With a completely circular ring-shaped transport securing element, the fixed position of the rotor would be set randomly.

Furthermore, according to further particularly preferred embodiment variants of the invention, it is provided that the respective transport securing element can be removed from the housing in a radial direction or in an axial direction. This also favors easy handling and assembly and disassembly of the respective transport securing element. Removal of the respective transport securing element can be particularly simple and advantageous if the transport securing element can be pulled off or removed from the housing in the axial direction.

Furthermore, it is advantageous if the housing forms a radially extending first, upper boundary wall on its upper side in the axial direction, against which one of the transport securing elements can be placed. This creates an easily accessible and flat and therefore advantageous mounting position for the first, upper transport securing element.

According to a further particularly preferred embodiment variant of the invention, it is provided that a first, upper cylindrical projection adjoins the first boundary wall in the axial direction, which is arranged coaxially with respect to an outer casing of the housing and has a smaller diameter than the outer casing, wherein the first, upper cylindrical projection forms a hollow chamber into which the upper rotor magnet is inserted. The first upper cylindrical projection serves to apply the one or one of the transport securing elements and forms a stop in the radial direction for the first, upper transport securing element, thereby enabling simple and precise mounting of the transport securing element, which can thus act in a defined manner on the upper rotor magnet or the rotor.

Furthermore, it is advantageous that the housing forms a second, radially extending lower boundary wall on its lower side in the axial direction, against which one of the transport securing elements can be placed. This creates an easily accessible and flat and therefore advantageous mounting position for the second, lower transport securing element.

It is also advantageous that a second lower cylindrical projection adjoins the second boundary wall in the axial direction, which is arranged coaxially with respect to the outer casing of the housing and has a smaller diameter than the outer casing, wherein the second, lower cylindrical projection forms a hollow chamber into which the lower rotor magnet is inserted. The second, lower cylindrical projection serves to apply the one or one of the transport securing elements and forms a stop in the radial direction for the optional second, lower transport securing element, thereby enabling simple and precise mounting of the transport securing element, which can thus act in a defined manner on the upper rotor magnet.

Furthermore, according to a further particularly preferred embodiment variant of the invention, it is provided that at least one first, upper transport securing element is placed on the first upper boundary wall of the housing or an upper axial boundary of the housing and that a second, lower transport securing element is placed on the second, lower boundary wall of the housing. In this way, the transport securing element(s) can be placed easily and securely on the housing.

The fact that the first, upper transport securing element is arranged adjacent to the first, upper cylindrical projection, against which the first, upper transport securing element can rest on the outside, advantageously ensures that the first, upper transport securing element can act in a defined and secure manner on the upper rotor magnet.

According to a further particularly preferred embodiment variant of the invention, it is provided that the first, upper transport securing element acts in a radial direction on the upper rotor magnet, so that the rotor rests against an inner wall of a lateral surface of the first, upper cylindrical projection in the region of the upper rotor magnet of the rotor. This creates a fixed, defined position of the rotor during transportation, which ensures safe transportation in which the rotor is secured against spontaneous movements.

Alternatively, according to a further particularly preferred embodiment variant of the invention, it can be provided that the first upper transport securing element acts on the upper rotor magnet in the radial direction and in the axial direction. This ensures advantageously safe transport securing even for larger and heavier separator inserts. The axial effect of such a first upper transport securing element fixes the rotor axially. The radial effect makes it possible, for example, to center the rotor or to have it rest radially against the inner wall of the first upper cylindrical projection of the rotor housing.

In a further particularly preferred embodiment variant of the invention, it is provided that the first, upper transport securing element has a center point or sector angle of preferably 250° to 290°, particularly preferably 270°. This provides a simple design and thus advantageously a robust upper transport securing element with secure function and simple assembly.

Alternatively, according to a further particularly preferred embodiment variant of the invention, it can be provided that the upper transport securing element is designed in two or more parts and the respective partial transport securing element has a center point or sector angle of between 45° and 180°. As a result, the upper transport securing element can be easily and therefore advantageously adapted to the forces required for safe transportation and safe assembly and can be easily assembled and particularly easily disassembled. The rotor can also be radially centered in the housing by a corresponding arrangement of two or more transport securing elements.

Furthermore, according to a further particularly preferred embodiment variant of the invention, it is provided that the second, lower transport securing element has a center point or sector angle of between 90° and 180°. As a result, the lower transport securing element can be easily and thus advantageously mounted and particularly easily removed.

According to a further particularly preferred embodiment variant of the invention, it is provided that the lower transport securing element acts on the lower rotor magnet in a radial direction, so that the lower rotor magnet of the rotor rests against an inner wall of a lateral surface of the second, lower cylindrical projection of the housing. This creates a fixed, defined position of the upper rotor magnet during transportation, which ensures safe transportation during which the rotor is secured against spontaneous movements.

Furthermore, according to a further particularly preferred embodiment variant of the invention, it may be provided that buffer elements with elastic properties are attached to the respective transport securing element, so that direct contact between the respective transport securing element and the housing is prevented. This results in a particularly gentle and possibly also hygienically simple and safe transport securing means.

It is also conceivable to only provide a transport securing element at the top or bottom. In this case, however, the transport securing means is less optimal than if one or more transport securing elements are attached to the top and bottom of the housing.

### BRIEF DESCRIPTION OF THE DRAWING FIGURES

In the following, the invention is described in more detail with reference to the drawing by means of exemplary embodiments. The invention is not limited to these exemplary embodiments, but can also be realized in other ways according to the wording or in other equivalent ways, wherein:

FIG. 1: shows a schematic sectional view of a separator insert including stator magnets for a separator;

FIG. 2: shows a schematic sectional view of the separator insert from FIG. 1 with a transport securing means according to a first embodiment variant;

FIG. 3: shows a spatial representation of an upper section of the separator insert from FIG. 2;

FIG. 4: shows a spatial representation of a lower section of the separator insert from FIG. 2;

FIG. 5: shows a spatial representation of the separator insert from FIG. 2, showing both the lower section and the upper section;

FIG. 6: shows a schematic sectional view of the separator insert from FIG. 1 with a transport securing means according to a second embodiment variant;

FIG. 7: shows a spatial representation of an upper section of the separator insert from FIG. 6;

FIG. 8: shows a spatial representation of a lower section of the separator insert from FIG. 6;

FIG. 9: shows a spatial representation of the separator insert from FIG. 6, showing both the lower section and the upper section.

### DETAILED DESCRIPTION

Several exemplary embodiments are described in the following description of the figures. The individual features of these exemplary embodiments can also be combined with exemplary embodiments not shown and are also suitable in each case as advantageous designs of the objects described in individual or several of the main claims and sub-claims.

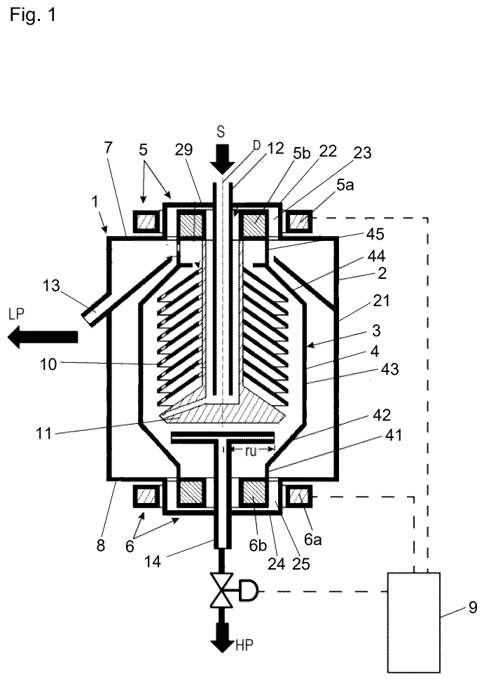

FIG. 1 shows a separator insert 1 of a separator, wherein the separator insert 1 has in each case a housing 2 and a rotor 3 which is inserted into the housing 2 and can rotate relative to the housing 2 during operation. The rotor 3 has an axis of rotation D. This can be aligned vertically, but it can also be aligned differently in space. In this respect, the term vertical is to be understood broadly. The terms “top” and “bottom” refer in each case to a first and a second position of the axis of rotation in the orientation selected in space.

The rotor 3 has a rotatable drum 4. During operation, the rotor 3 is held in suspension by magnetic bearings of a frame not otherwise shown here (see DE 10 2020 121 419 A1). Outside of operation, when the magnetic bearings are not active—e.g., during transportation or assembly in a frame provided for this purpose-the rotor is in an undefined state in the housing, as it is neither axially nor radially fixed without an additional transport securing means.

During operation, the rotor 2 is rotatably mounted in the frame at two locations axially spaced apart from each other in the direction of the axis of rotation with respective magnetic bearing devices.

For this purpose, the separator insert 1 has an upper rotor magnet 5b and a lower rotor magnet 6b of the magnetic bearing devices 5, 6, wherein the magnetic bearing devices are completed by stator magnets 5a, 6a of the frame (shown here without the rest of the frame).

Preferably, positive locking means are provided (also not shown), which can be designed as projections and recesses in order to hold the housing 2 non-rotatably on the stator magnets 5a, 6a and thus on the frame.

The magnetic bearing devices 5, 6 preferably act radially and axially and preferably keep the rotatably mounted rotor 3 suspended in the housing 2 at a distance from it during operation of the separator.

Such a separator with the easily exchangeable separator insert 1, which preferably consists entirely or essentially of plastic, can be useful and advantageous when processing products where it must be ruled out with a very high degree of certainty that impurities will be introduced into the product—a flowable suspension S or its phases LP, HP or LP1, LP2—during centrifugal processing or where cleaning and disinfection of the separator would be very time-consuming or not possible at all.

The housing 2 is preferably made of a plastic or plastic composite material. The housing 2 can be cylindrical and have a cylindrical outer casing 21.

In the case of an alignment with a vertical axis of rotation D—as shown in FIG. 1—the housing 2 preferably forms a radially extending first-here upper-boundary wall 7 on its upper side in the axial direction, which is formed here quasi as an upper cover section. A first—here upper—cylindrical projection 22, which is arranged coaxially to the outer casing 21 and has a smaller diameter than the outer casing 21, adjoins the first boundary wall 7 in the axial direction. The first, here upper, cylindrical projection 22 forms a hollow chamber 23 into which the upper rotor magnet 5b is inserted.

On its lower side, the housing 2 also forms a radially extending second—here lower—boundary wall 8 in the axial direction, which in this case is more or less designed as a lower base.

A second—here lower—cylindrical projection 24, which is arranged coaxially to the outer casing 21 and has a smaller diameter than the outer casing 21, preferably adjoins the second boundary wall 8 in the axial direction. The second, lower cylindrical projection 24 forms a hollow chamber 25 into which the lower rotor magnet 6b is inserted.

The drum 4 is used for centrifugal separation of a flowable suspension S in the centrifugal field into at least two phases LP, HP of different densities, which can be, for example, a lighter liquid phase LP or LP1 and a heavy solid phase HP or a heavy liquid phase LP2.

The drum 4 is preferably cylindrical and/or conical in at least some sections. The housing 2 is designed in the manner of a container, which is advantageously hermetically sealed except for some openings/opening areas.

As shown, the drum 4 can have a lower cylindrical section 41 of smaller diameter, on/in which the lower rotor magnet 6b of the lower magnetic bearing 6 is also formed, which merges into a lower conical section 42, then has a cylindrical section 43 of larger diameter here, for example, then has an upper conical section 44 and then an upper cylindrical section 45 of smaller diameter, on which the rotor magnet 5b of the upper magnetic bearing 5 is formed. Such a design of the drum 4 is advantageous, but not mandatory.

The drum 4 contains internals such as a separator disk assembly 10 and a distributor 11. The housing 2 has a feed line 12 for feeding the suspension S to be separated or clarified into the drum 4, as well as discharge lines 13, 14 for discharging the phases LP, HP or LP1, LP2 resulting from the centrifugation process.

When the separator is not in operation, i.e., when the magnetic bearings 5, 6 are not active, e.g., during transportation or assembly of the separator insert 1, the rotor 3 is in an undefined state in the housing 2, as it is neither axially nor radially fixed without an additional transport securing means. This is because the respective rotor magnets have limited axial and/or radial movement in the housing or are not rigidly fixed in the housing. During transportation, this could lead to damage to the drum 4 and its internals, e.g., separator disk assembly 10, distributor 11 or also the housing 2 and its internals—e.g., feed line 12 and discharge lines 13, 14.

The structure of the separator insert described above is advantageous but exemplary and can therefore be designed differently within the scope of the invention, even to the extent defined by the claims.

To prevent the drum 4, which is free-floating during operation of the separator, from moving in the housing 2 during transport, it is provided that at least one, here in a preferred design at least one first and one second transport securing element 100 are provided, which are attached to the outside of the housing and interact there with one of the rotor magnets 5b or 6b by forcing it into a defined position in the housing 2. Preferably, the respective rotor magnet 5b, 6b is forced into a position in which it rests against the inside of the housing 2.

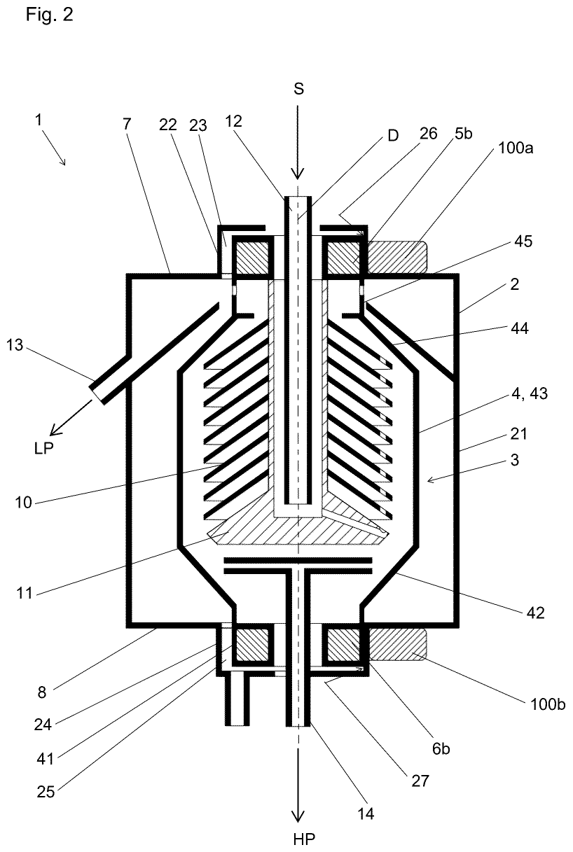

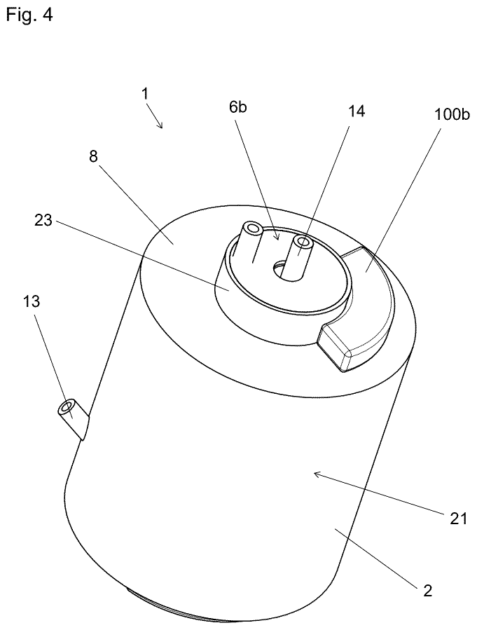

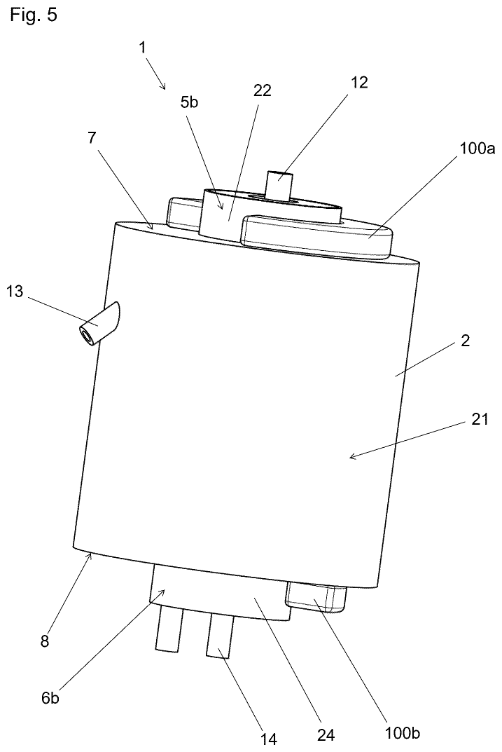

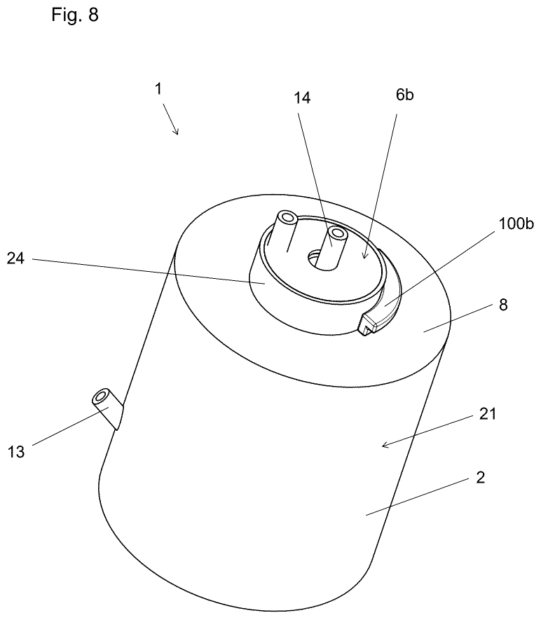

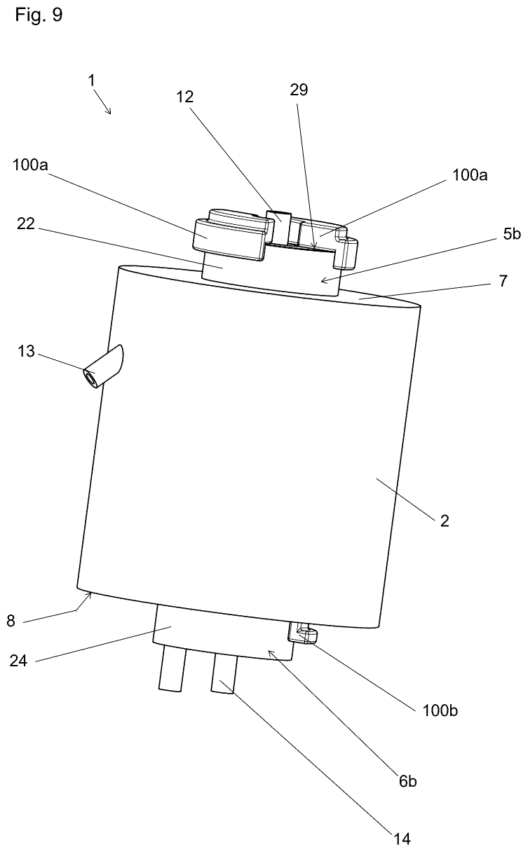

Preferably, a first, upper transport securing element 100a and a second, lower transport securing element 100b are each placed in the area of the rotor magnets 5b, 6b for fixing the rotor 3 to the outer contour of the housing 2, as shown in FIGS. 2 to 9 (in relation to a vertical alignment of the axis of rotation of the rotor during operation).

Here, the inner radius of the lower transport securing element 100b substantially corresponds to the outer radius of the second cylindrical projection 24 and an inner radius of the upper transport securing element 100a substantially corresponds to the outer radius of the first cylindrical projection 22.

The respective transport securing element 100a,b works according to a magnetic operating principle and is preferably ferromagnetic.

The respective transport securing element 100a,b can be circular ring-shaped or circular ring-sector-shaped. Ring-shaped elements or integral elements with a center or sector angle >180° can only be pulled off the housing 2 in the axial direction, which can be disadvantageous in the case of strong magnetic forces. Transport securing elements 100a,b with a center point or sector angle ≤180° can also be pulled off the housing 2 radially, which can be advantageous in the case of high magnetic forces. In the case of high magnetic forces, several small circular ring sector-shaped partial transport securing elements 100a, b with a correspondingly small center point or sector angle of <90°, for example, can also be used in order to facilitate handling when removing the transport securing elements 100a,b on the one hand, and to ensure sufficient fixation of the rotor 3 for transport on the other.

FIGS. 2 to 5 show a first embodiment variant of the transport securing elements 100a,b.

In order to fix the rotor 3 for transport in the housing 2, the first, upper circular ring sector-shaped transport securing element 100a is first placed with a center point or sector angle of preferably 180° to 290°, particularly preferably 270° in the region of the rotor magnet 5b in the radial direction on the first, here upper boundary wall 7 of the housing 2. In this case, the first, upper transport securing element 100a is arranged adjacent to the first, here upper cylindrical projection 22, against which the first, upper transport securing element 100a can rest on the outside.

The first, upper transport securing element 100a acts here in a radial direction on the upper rotor magnet 5b.

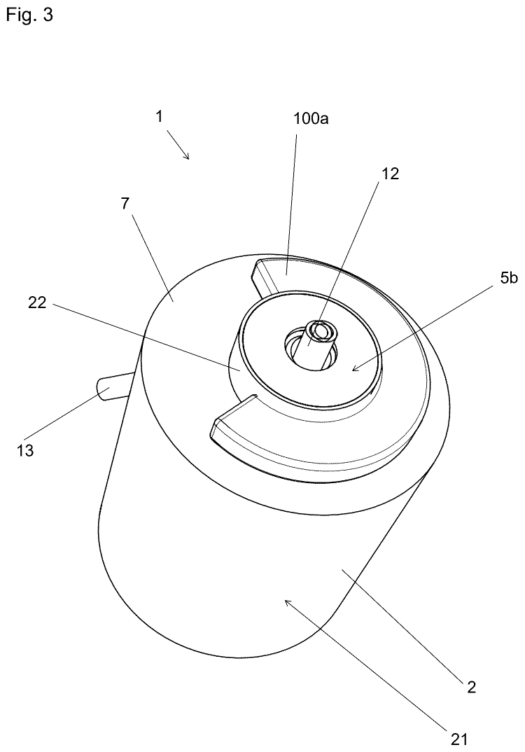

The upper rotor magnet 5b of the rotor 3 will therefore align itself axially centrally to the first, upper transport securing element 100a and rest radially approximately in the region of the center of the first, upper transport securing element 100a against an inner wall 26 of a lateral surface of the first, upper cylindrical projection 22. This also fixes the rotor 3, in which the rotor magnet 5b is attached, in a defined position (see FIGS. 2 and 3).

With suitably selected magnetic forces, the integral upper transport securing element 100a can be removed axially from the housing before the housing is inserted into the frame with the stator magnets.

Preferably following the installation of the upper transport securing element 100a, the lower rotor magnet 6b is also fixed with the lower transport securing element 100b. This can be designed to be “smaller” than the upper one, for example, and can form a center point or sector angle of between 90° and 180°. It can be placed in a radial direction on the second, in this case lower, boundary wall 8 of the housing 2. In this case, the second, lower transport securing element 100b can be arranged adjacent to the second, here lower cylindrical projection 24 on the outside of the housing 2, against which the second, lower transport securing element 100b can rest on the outside.

This lower transport securing element 100b can be placed in its position both axially and radially or removed again from this position.

Thus, the second lower transport securing element 100b also acts in a radial direction on the lower rotor magnet 6b. As a result, the lower rotor magnet 6b of the rotor 3 will also rest against an inner wall 27 of a lateral surface of the second, lower cylindrical projection 24.

In order to prevent direct contact of the ferromagnetic material of the respective transport securing element 100a,b with the housing 2, buffer elements (not shown) with elastic properties can be attached to the respective transport securing element 100a,b.

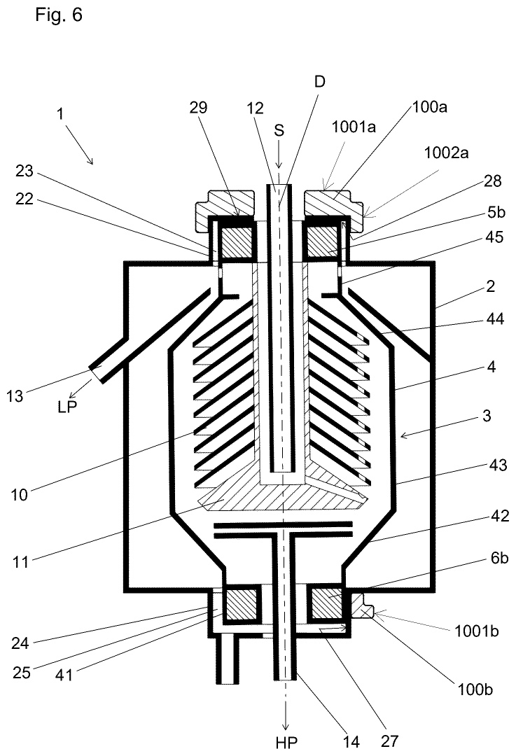

FIGS. 6 to 9 show a second embodiment variant of the transport securing elements 100a,b.

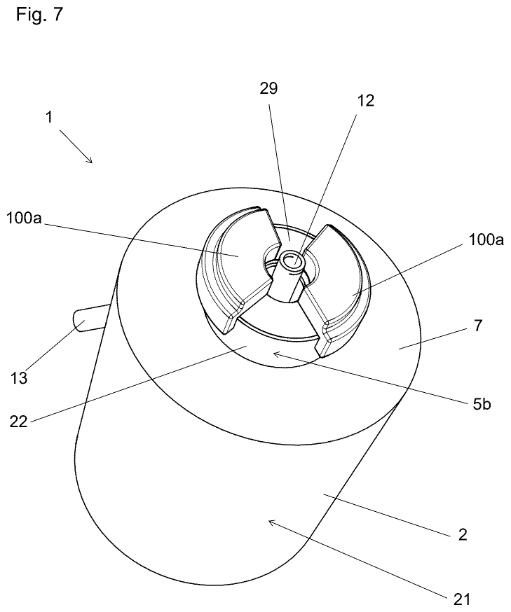

These are particularly suitable for a larger rotor 3 with stronger rotor magnets 5b, 6b. In order to fix this larger rotor 3 with stronger rotor magnets 5b, 6b for transport in the housing 2, two or more first—in this case upper circular ring sector-shaped transport securing elements 100a are first placed axially on an upper axial boundary 29 of the first, upper cylindrical projection 22 of the housing 2, each with a center point or sector angle between approximately 90° and 180° (see FIGS. 6 and 7).

The two or more first, upper partial transport securing elements 100a or the upper transport securing element 100a in its entirety acts or act here primarily in the axial direction on the upper rotor magnet 5b.

The upper rotor magnet 5b of the rotor 3 will therefore primarily align itself axially in the direction of the two or more first upper transport securing elements 100a and align itself radially with the position of the two or more upper transport securing elements 100a. In this case, the upper rotor magnet 5b of the rotor 3 will axially contact an inner wall 28 of the upper axial boundary 29 of the first, upper cylindrical projection 22 and possibly align itself radially in a centered position (see FIG. 6). As a result, the rotor 3, in which the rotor magnet 5b is fixed, is also axially and radially fixed.

According to Fig, 6, regions of different internal diameters are formed on the upper transport securing element 100a in such a way that the upper transport securing element 100a rests axially “on top” of the first cylindrical projection 22 with a first region 1001a of smaller internal diameter and in such a way that it engages around this projection 22 in a ring-like manner with another region 1002a of larger internal diameter resting against its outer circumference. Analogous features could also be formed on the lower transport securing element 100b (not shown here).

Subsequently, the lower rotor magnet 6b can also be placed with a second, lower circular ring sector-shaped transport securing element 100b with a center point or sector angle between approximately 90° and 180° on the second, here lower boundary wall 8 of the housing 2. In this case, the second, lower transport securing element 100b is placed adjacent to the second, here lower cylindrical projection 24 of the housing, against which the second, lower transport securing element 100b can rest on the outside.

This second, lower transport securing element 100b can be placed in its position both axially and radially or removed again from this position. In the case of higher magnetic forces, it can therefore be useful according to a variant to design the first upper transport securing element 100a in several parts, so that it can be easily removed axially or radially.

The second lower transport securing element 100b acts essentially in a radial direction on the lower rotor magnet 6b. As a result, the lower rotor magnet 6b of the rotor 3 will also rest against the inner wall 27 of the lateral surface of the second, lower cylindrical projection 24 (see FIG. 6).

The first and/or the second transport securing element 100a,b can also be designed in a stepped manner on the outer circumference, i.e. regions of different internal diameters or outer diameters are then formed there. Thus, according to FIG. 6, a kind of radial projection 1001b can be formed on the lower transport element 100b, which facilitates handling.

This also fixes the rotor 3, in which the rotor magnet 6b is attached, radially in a defined position.

In order to prevent direct contact of the respective transport securing element 100a,b with the housing 2, buffer elements (not shown) with elastic properties can be attached to the respective transport securing element 100a,b.

### LIST OF REFERENCE SIGNS

1 Separator insert
2 Housing
21 Outer casing
22 First cylindrical projection
23 Hollow chamber
24 Second cylindrical projection
25 Hollow chamber
26 Inner wall
27 Inner wall
28 Inner wall
29 Upper axial boundary
3 Rotor
4 Drum
41 Lower cylindrical section
42 Lower conical section
43 Middle cylindrical section
44 Upper conical section
45 Upper cylindrical section
5 Upper magnetic bearing
5a Upper stator magnet
5b Upper rotor magnet
6 Lower magnetic bearing
6a Lower stator magnet
6b Lower rotor magnet
7 Upper boundary wall
8 Lower boundary wall
9 Control unit
10 Separator disk assembly
11 Distributor
12 Feed line
13 Discharge line
14 Discharge line
100a, b Transport securing element
1001a, 1002a Regions
1001b Projection
S Suspension
LP, HP Flowable phases
D Axis of rotation

1-24. (canceled)

25. A separator insert for a separator, the separator insert comprising:
a housing that is stationary during operation and is configured as a container that is closed except for one or more housing openings;
a rotor, arranged within the housing, rotatable about an axis of rotation and having a drum with one or more drum openings;
at least two rotor magnets at two axially spaced points of the rotor, wherein the at least two rotor magnets are configured to hold the rotor in suspension and rotatably support the rotor within the housing during the operation; and
one or more transport securing elements configured for transportation or assembly of the separator insert, wherein the one or more transport securing elements operate according to a magnetic operating principle so that the drum, which is free-floating during operation of the separator, is immovable or substantially immovable in the housing during transport or installation,
wherein the separator insert is a preassembled, exchangeable unit insertable into a frame and configured to separate a flowable suspension in a centrifugal field into at least two flowable phases of different density, wherein the separator insert is configured to be inserted into stator magnets on the frame of the separator.

26. The separator insert of claim 25, wherein the one or more transport securing elements operate according to a ferromagnetic operating principle.

27. The separator insert of claim 25, wherein the rotor and the at least one of the at least two rotor magnets in the housing, before attachment of the one or more transport securing elements to the separator insert, are rotatable, axially or radially movable to a limited extent in the housing, and are not fixed rigidly in the housing.

28. The separator insert of claim 25, wherein a respective one of the one or more transport securing element is placed on an outside of the housing in such a way that the respective one of the one or more transport securing element moves a respective one of the at least two rotor magnets so that a freedom of movement of the rotor and the respective one of the at least two rotor magnets in the housing is restricted.

29. The separator insert of claim 25, wherein the one or more transport securing elements have a circular ring sector-shaped geometry.

30. The separator insert of claim 25, wherein a respective one of the one or more transport securing element or elements is configured so it can be pulled off the housing substantially in an axial direction.

31. The separator insert of claim 25, wherein a respective one of the one or more transport securing element or elements is configured so that it can be pulled off the housing substantially in a radial direction.

32. The separator insert of claim 25, wherein the housing has, on an upper side in an axial direction of the housing, a radially extending first, upper boundary wall, against which one of the one or more transport securing elements is placeable.

33. The separator insert of claim 32, wherein a first, upper cylindrical projection adjoins the first, upper boundary wall in the axial direction, which is arranged coaxially with respect to a remaining cylindrical outer casing of the housing, wherein the projection has a smaller diameter than the remaining cylindrical outer casing, wherein the first, upper cylindrical projection forms a hollow chamber into which an upper rotor magnet of the at least two rotor magnets is inserted, wherein one of the one or more transport securing elements is placeable against the upper projection.

34. The separator insert of claim 33, wherein the housing forms a radially extending second lower boundary wall on a lower side of the housing in the axial direction, against which one of the one or more transport securing elements is placeable.

35. The separator insert of claim 34, wherein a second lower cylindrical projection adjoins the second boundary wall in the axial direction, wherein the second lower cylindrical projection is arranged coaxially with respect to the remaining cylindrical outer casing of the housing and has a smaller diameter than the remaining cylindrical outer casing, wherein the second, lower cylindrical projection forms a hollow chamber into which a lower rotor magnet of the at least two rotor magnets is inserted, wherein one of the one or more transport securing elements is placeable against the lower projection.

36. The separator insert of claim 35, wherein
at least one first, upper transport securing element of the one or more transport securing elements is placed on the first, upper boundary wall of the housing or on an upper axial boundary of the housing, or
at least one second, lower transport securing element of the one or more transport securing elements is placed on the second, lower boundary wall of the housing.

37. The separator insert of claim 36, wherein the at least one first, upper transport securing element is arranged adjacent to the at least one first, upper cylindrical projection, against which the at least one first, upper transport securing element rests radially or axially on an outside.

38. The separator insert of claim 36, wherein the first, upper transport securing element acts substantially in the radial direction on the upper rotor magnet, so that the upper rotor magnet of the rotor rests against an inner wall of a lateral surface of the at least one first, upper cylindrical projection.

39. The separator insert of claim 36, wherein the at least one first, upper transport securing element acts on the upper rotor magnet in the radial direction and in the axial direction.

40. The separator insert of claim 36, wherein the at least one first, upper transport securing element has a center point or sector angle of 180° to 290°.

41. The separator insert of claim 36, wherein the at least one first, upper transport securing element is two or more parts and a respective partial transport securing element of the at least one first, upper transport securing element has a center point or sector angle of between 45° and 180°.

42. The separator insert of claim 36, wherein the upper rotor magnet of the rotor is aligned axially centrally with respect to the placed at least one first, upper transport securing element and rests radially approximately against the center of the at least one first, upper transport securing element.

43. The separator insert of claim 36, wherein the at least one first, upper transport securing element comprises two or more upper transport securing elements, wherein the upper rotor magnet is axially aligned in a direction of the two or more upper transport securing elements when the two or more upper transport securing elements are placed on top of the separator insert so that the upper rotor magnet of the rotor axially rests against an inner wall of the upper axial boundary of the first, upper cylindrical projection and is radially aligned with a position of the two or more transport securing elements mounted on top.

44. The separator insert of claim 36, wherein one or all of the one or more transport securing elements have regions of different inner or outer diameters.

45. The separator insert of claim 44, wherein on one or all of the one or more transport securing elements the regions of different internal diameters are formed in such a way that the respective one of the one or all of the one or more transport securing elements rests with a first region of smaller internal diameter axially on the first or the second cylindrical projection and in such a way that the respective one of the one or all of the one or more transport securing elements engages around the first or the second cylindrical projection with another region on an outer circumference in a ring-like manner, resting against the first or the second cylindrical projection.

46. The separator insert of claim 36, wherein the second, lower transport securing element has a center point or sector angle of between 90° and 180°.

47. The separator insert of claim 36, wherein the second, lower transport securing element acts on the lower rotor magnet in the radial direction, so that the lower rotor magnet of the rotor rests against an inner wall of a lateral surface of the second, lower cylindrical projection.

48. The separator insert of claim 25, wherein buffer elements with elastic properties are attached to a respective one of the one or more transport securing element, so that direct contact between the respective one of the one or more transport securing element and the housing is prevented.
